(19) United States
(12) Patent Application Publication
(10) Pub. No.: US 2026/0251012 A1
(43) Pub. Date: Aug. 27, 2026

(54) SMART SELF-POWERED WINDOW WITH POD CONCEPT AND CHARGER SYSTEM

(71) Applicant: Andluca Technologies Inc., Rochester, NY (US)

(72) Inventors: Thomas Schumann, Carson City, NV (US); Adrian Winoto, San Francisco, CA (US); Ismet Tudjinovic, Alameda, CA (US); Nicholas C. Davy, Houston, TX (US)

(21) Appl. No.: 19/662,411

(22) Filed: Apr. 29, 2026

Related U.S. Application Data
(63) Continuation of application No. PCT/US24/54293, filed on Nov. 1, 2024.
(60) Provisional application No. 63/664,446, filed on Jun. 26, 2024.
(60) Provisional application No. 63/546,902, filed on Nov. 1, 2023.

(51) Int. Cl. E06B 7/28; E06B 3/67; E06B 9/24; H02S 10/00; H02S 20/00

(52) U.S. Cl. CPC E06B 7/28; E06B 3/6722; E06B 9/24; H02S 10/00; H02S 20/00; E06B 2009/2464

(57) ABSTRACT

Illustrative embodiments present a self-contained window system that includes a solar-generating glass window, pods that contain components, an energy storage device, and electrical circuits that distribute electrical power that is generated by the solar-generating glass and distributed to the components and the energy storage device. The self-contained window system is secured to a structure that may be a window frame, a glazing bead, or the like. In illustrative embodiments, the pods are secured inside of the structure, while in other illustrative embodiments the pods are secured on the outside of the structure. Regardless of whether the pods are secured inside or outside of structure, the components in the pods are accessible and easy to maintain. The pods and components can be conveniently exchanged and upgraded.

### PRIORITY

This patent application is a continuation of International Patent Application No. PCT/US2024/054293, filed November 1, 2024, which claims priority from provisional United States patent application number 63/664,446, filed June 26, 2024, and entitled, “SMART SELF-POWERED WINDOW WITH POD CONCEPT AND CHARGER SYSTEM, and from provisional United States patent application number 63/546,902, filed November 1, 2023, and entitled, “SMART SELF-POWERED WINDOW WITH POD CONCEPT AND INTERNAL-EXTERNAL FUNCTION,” the disclosures of which are incorporated herein, in their entirety, by reference.

### FIELD

Illustrative embodiments of the invention generally relate to self-powered windows and, more particularly, various embodiments of the invention relate to smart, self-powered windows with various components and battery storage.

### BACKGROUND

There is interest in increasing the functionality of windows. For instance, in addition to providing a transparent barrier between the interior and exterior of a structure, designers have conceived of windows that provide improved thermal insulation, automatically changeable color tints, electrochromic functionality, and the like. Some of the desired functions to include with modern windows include electrical components. Since those electrical components require electrical power, a source of power must be connected to the windows to enable operation.

### SUMMARY OF VARIOUS EMBODIMENTS

In accordance with one embodiment of the invention, a self-powered window system includes solar-generating glass. The solar-generating glass is configured to provide a source of electrical power to the window system. The self-powered window system includes also one or more pods configured to hold one or more features, and an energy management system in electrical communication with the solar-generating glass. The energy management system is configured to optimize storage and distribution of the electrical power provided by the solar-generating glass.

The self-powered window system also includes at least one energy storage device positioned in at least one pod. The at least one energy storage device is configured to be in electrical communication with the solar-generating glass.

The self-powered window system also includes one or more electrical circuits configured to distribute the electrical power to the one or more pods and the at least one energy storage device; and a structure configured to secure at least the solar-generating glass, the one or more pods, and the at least one energy storage device within the structure.

The window system is self-contained such that the electrical power required to operate the one or more features, to energize the one or more electrical circuits, and charge the at least one energy storage device is provided by the solar-generating glass.

The one or more features may include at least one of a power pod, a security pod, a privacy pod, a gas sensor pod, an alarm pod, a clock pod, a camera pod. The one or more pods are reversibly installable in the structure.

The structure may include one or more glazing beads. The one or more glazing beads may include at least one of the one or more pods. The one or more pods may be configured to be reversibly mounted as part of the glazing beads.

The structure may also include a glazing bead configured to be mounted within a window frame. The one or more pods may be configured to mounted onto the window frame.

In accordance with another embodiment of the invention, a self-contained smart window system includes an energy harvesting component. The energy harvesting component comprises an insulated glass unit (IGU) comprising solar-generating glass configured to provide a source of electrical power to the window system.

The self-contained smart window system also includes an energy management component. The energy management component is in electrical communication with the solar-generating glass and configured to optimize storage and distribution of the electrical power generated by the solar-generating glass.

The self-contained smart window system also includes an energy storage component. The energy storage component includes one or more storage devices in electrical communication with the energy management component;

The self-contained smart window system also includes one or more energy consuming functional components. The one or more energy consuming functional components provide at least one of a privacy function, a security function, a dynamic window tinting function, or an on-demand power function.

The self-contained smart window system also includes a smart window system controller component. The smart window system controller component is in electrical communication with the energy harvesting component, the energy management component, the energy storage component, and the one or more energy consumption functional components and is configured to control energy management and the functional components.

The self-contained smart window system is mounted in a structure configured to secure at least the energy harvesting component, the energy management component, the energy storage component, smart window system controller component, and the one or more energy consumption components within the structure.

The self-contained smart window system is self-contained such that the electrical power required to power the components is provided by the solar-generating glass.

The self-contained smart window system may further include a smart home control component. The smart home control component may be in control communication with the smart window system controller.

The structure may include one or more glazing beads, a window frame, or both the one or more glazing beads and the window frame.

The solar-generating glass may convert ultra-violet (UV) light to electrical power. The solar-generating glass may include one or more of organic photovoltaic devices (OPV) or luminescent solar concentrator (LSC) devices. One or both of the OPV devices or LSC devices are UV OPV devices or UV LSC devices.

The IGU may further include one or more layers of dynamic glass. The one or more layers of dynamic glass may include an electrochromic (EC) layer. The EC layer May be electrically dimmable. The EC layer may electrically tintable.

The energy management component may include one or more energy management boards positioned in one or more pods reversibly installed in the structure.

The energy storage component may include one or more batteries positioned in one or more pods reversibly installed in the structure.

The privacy function may include providing a motorized smart shade integrated into a privacy pod reversibly installed in the structure.

The security function may include features including one or more of a security camera, a proximity sensor, a speaker, a motion sensor, or lock and unlock sensors paired with impact-resistant glass in one or more pods reversibly installed in the structure.

The dynamic window tinting function may include an EC layer in the IGU. The on-demand power function may include a power pod insert reversibly installed in the structure.

In accordance with another embodiment of the invention, a method of providing privacy, security, and energy efficiency to an interior structure having a window frame includes providing a self-contained smart window system, and mounting the self-contained smart window system in the window frame. The self-contained smart window system includes solar-generating glass. The solar-generating glass is configured to provide a source of electrical power to the window system. The self-contained smart window system also includes one or more pods configured to hold one or more features. The self-contained smart window system includes an energy management system in electrical communication with the solar-generating glass. The energy management system is configured to optimize storage and distribution of the electrical power provided by the solar-generating glass. The self-contained smart window system also includes at least one energy storage device positioned in at least one pod. The at least one energy storage device is configured to be in electrical communication with the solar-generating glass. The self-contained smart window system also includes one or more electrical circuits configured to distribute the electrical power to the one or more pods and the at least one energy storage device. The self-contained smart window system also includes a structure configured to secure at least the solar-generating glass, the one or more pods, and the at least one energy storage device within the structure. The window system is self-contained such that the electrical power required to operate the one or more features, to energize the one or more electrical circuits, and charge the at least one energy storage device is provided by the solar-generating glass.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows a schematic illustration of a high-level system design of a self-powered smart window system according to an embodiment of the present disclosure.

FIG. 2A shows a rendering of an embodiment of a self-powered smart window design viewed from the inside of the window according to an embodiment of the present disclosure.

FIG. 2B shows an expanded illustration of the low power charging feature pod according to an embodiment of the present disclosure.

FIG. 2C shows an embodiment of a charging pod section according to an embodiment of the present disclosure.

FIG. 3A shows a rendering of an embodiment of a self-powered smart window design including a pod with security shade and security features according to an embodiment of the present disclosure.

FIG. 3B shows an expanded rendering of an embodiment of a self-powered smart window design highlighting the security features according to an embodiment of the present disclosure.

FIG. 4A illustrates mounting a pod with a privacy shade and security features according to an embodiment of the present disclosure.

FIG. 4B further illustrates mounting a pod in a window shade according to an embodiment of the present disclosure.

FIG. 5 shows a drawing illustrating details of an integrated adaptive shade according to an embodiment of the present disclosure.

FIG. 6A shows a photograph of the front of a security pod as part of self-powered smart window design according to an embodiment of the present disclosure.

FIG. 6B shows a photograph of the back of the security pod of the self-powered smart window design according to an embodiment of the present disclosure.

FIG. 7A shows a rendering of an embodiment of a self-powered window that includes cut-away illustrations of upper and lower right corners of the window according to an embodiment of the present disclosure.

FIG. 7B shows a drawing of the backside of a self-powered window that illustrates devices inside a pod with the cover removed according to an embodiment of the present disclosure.

FIG. 8A shows a rendering of an embodiment of a self-powered smart window system with pods located on a surface on a window frame or window glazing viewed from the inside of the window according to an embodiment of the present disclosure.

FIG. 8B shows a rendering of an expanded portion of the window embodiment of a self-powered smart window system with a display as part of the IGU according to an embodiment of the present disclosure.

FIG. 9A shows a rendering of an embodiment of easy insertion, engagement, and removal of pods on a surface of the self-powered smart window system according to an embodiment of the present disclosure.

FIG. 9B shows another rendering of an embodiment of easy insertion, engagement, and removal of pods according to an embodiment of the present disclosure.

FIG. 9C shows an additional rendering of an embodiment of easy insertion, engagement, and removal of on a surface of the self-powered smart window system according to an embodiment of the present disclosure.

FIG. 10A shows a rendering of an embodiment of a self-powered smart window system with pods located on the surface on a window frame with a closed window according to an embodiment of the present disclosure.

FIG. 10B shows a rendering of an embodiment of a self-powered smart window system with pods located on the surface on a window frame with an open window according to an embodiment of the present disclosure.

FIG. 11 shows a solar-powered glass window IGU having electrical connections and showing a connection to the IGU according to an embodiment of the present disclosure.

### DESCRIPTION OF ILLUSTRATIVE EMBODIMENTS

Illustrative embodiments present a self-contained window system that includes a solar power generating (e.g., solar-generating) glass window, pods that contain components, an energy storage device, and electrical circuits that distribute electrical power that is generated by the solar-generating glass and distributed to the components and the energy storage device. The self-contained window system is secured to a structure that may be a window frame, a glazing bead, or the like. The solar-generating window may also be called an insulated glass unit (e.g., IGU). In embodiments, the IGU may include glass layers with electrochromic layers that can provide dimming and/or tinting functionality to the window system. The solar generating window may use photovoltaic (e.g., PV) materials and devices.

Other electrically-controlled dimmable device on a glass, plexiglass or film substrate that modulates the substrates opacity, transmissivity, haze, light scattering, light absorption, light reflection between the wavelengths 300 - 3000 nanometers, or between the wavelengths 8 - 12 micrometers.

In illustrative embodiments, the pods are secured inside of the structure, while in other illustrative embodiments the pods are secured on the outside of the structure. Regardless of whether the pods are secured inside or outside of structure, the components in the pods are accessible and easy to maintain. The pods and components can be conveniently exchanged and upgraded. Details of illustrative embodiments are discussed below.

Various embodiments present a significant improvement of an existing and/or common window and door products, with the significant improvements achieved by introducing new functionalities, features, application, integrations and unique engineering solutions to a window or door design to enable a powered window or door product with beneficial capabilities. Further, the features, designs, and methods described herein are unique for a window including a transparent or semitransparent solar glass as the primary power source for the window system, and/or the energy storage components such as batteries, and/or the associated window features. For example, motorized parts and sensors integrated in a window and with their ability to function as a self-powered window, without a connection to a power source external to the window, and not regularly needing an external power source to charge the battery that drives these applications, represents a significant improvement over the state of the art. The pod concept with reversible mechanical and electrical engagement/connection is a valuable innovation as a unique engineering solution for using transparent or semitransparent solar glass to enable a self-powered smart window with various features.

Illustrative embodiments improve on the state of the art by, among other ways, introducing new integrations and unique engineering solutions to a window to enable a feature-rich window product that is a unique system for a window.

Illustrative embodiments improve on designs, methods, and integrations not present in existing window products. Namely, some or all of these features in existing products and technologies seem to require a connection to a building’s electrical grid. If they are powered solely by a local battery or other energy storage device, then this the battery - having a limited charge and lifetime – has to be charged using an external power source away external from the window or window system.

The window frame can be made by traditional means depending on the type of materials used for construction. The pods have specific forms, and can be made by a variety of conventional manufacturing processes that can produce parts – preferably with high resolution. The main printed circuit board (e.g., PCB) and other PCB boards involved used in the window are made with common or up- to- date PCB board fabrication processes. Mechanical and electrical connectors and electrical wiring has to be assembled within and throughout the product.

The transparent or semitransparent solar glass involves assembling electronics to a glass that generates power from solar or other electromagnetic radiation, converting the solar or other radiation to energy to power the window system. In one particular embodiment, the system utilizes a laminated glass or glass coating that converts ultraviolet (UV) light into energy. In another embodiment, the system utilizes a laminated glass or glass coating that absorbs a portion of visible or near-infrared light from solar radiation, or indoor or outdoor artificial lighting, and converts the absorbed light into electrical power through a photovoltaic and/or luminescent solar concentrator approach to be able to convert UV light into energy. One example of UV solar glass is commercialized by Andluca Technologies of Princeton, NJ.

In some embodiments, UV transparent or semitransparent solar glass that harvests ultraviolet light and/or a portion of visible or near-infrared light along with the associated energy storage and management system is utilized as core integration in this window.

### Pod Concepts

The pod concept allows different features or applications to be added (or removed) or upgraded to a window that has been equipped with existing compatible pod receptacle slots. In some embodiments, the pod concept allows this upgrade or installation to be done in some cases by hand and without any tools, by one or more a mechanical methods for easy fitting of a pod into a pod receptacle. The necessary electrical connection is achieved through a quick pogo-pin based connection from the pod receptacle to the pads on the pods, and can be achieved via other electrical or mechanical interfaces between the pod and pod receptacle. Other embodiments may involve use of tools for installation.

One pod solution involves temperature and humidity sensors that allows for sensing the outdoors conditions, without compromising but does not compromise the core function purpose of a window to isolate the indoor conditions from outdoor weather such as precipitation. The window design does not compromise electrical components with respect to the outdoor weather and natural elements. The same concept can be applied to other sensors such as air quality sensors, occupancy sensors, acoustic sensors, in addition to not just measuring temperature and humidity.

The use of a self-powered smart window is fundamentally the same as the use for an average standard window in that the self-powered window is designed to isolate the inside indoor space from the elements on the outdoor side of the window, but while allowing the outdoors to be visible to an indoor occupant – absent any window coverings, dressings, or switchable or dynamic glass. This isolation is specifically pertinent to the weather conditions, thermal conditions, and sound conditions. It differs from a wall because windows allow a person inside to see outside.

The self-powered smart window is different from a traditional standard window because it enables features and applications that require power to be integrated with the window without the need to wire the window from building electrical or to be connected to any other external power source separate or away from the window. For this self-powered smart window, the power may be directed to the pod receptacles that can power the desired features and applications on of the pods.

Various embodiments of the pod concept can be used with one or more of proximity sensors, temperature sensors, humidity sensors, cameras, displays, command buttons, on/off buttons, power buttons, and motorized parts. In fact, this pod concept can be used for a wide variety of other applications that require power. The power required for window applications preferably is within no greater than the limits of the battery local energy storage components, such as the battery, and no greater than the ability of the ability of the UV solar glass to replenish the power energy in the battery over a reasonable period of time.

Illustrative embodiments include a solution for temperature and humidity sensors that allow for sensing the outdoors condition, but does not compromise the core function of the window to isolate the outside outdoors from the indoors. It also does not compromise mechanical or electrical components to the outside elements. The same concept can be applied to a variety of other sensors, in addition to not just temperature and humidity sensors and/or devices.

The window frame can be made by traditional means depending on the type of material. The pods will have specific forms, and can be made with conventional manufacturing process that can produce parts – particularly manufacturing processes that can produce parts with high resolution. The PCB boards involved are made with up-to-date PCB board fabrication processes. Connectors and wiring have to be assembled throughout the product.

Individual pods and their specific functions can have a wide range of functionality, as long as their power demands are within the capacity of the included battery and the UV solar glass’s ability of the transparent or semitransparent solar glass to replenish the power in that battery or other energy storage device.

Magnets may be used to reversibly bind exterior components or pieces of the window housing (such as covers) to protect the inner compartments. For example, magnets may be used to reversibly bind pods and pod receptacles to the housing, and may also be used to hold components such as electronics, and sensors.

In some embodiments, UV solar glass that harvests ultraviolet light and/or a portion of visible light has specific and unique advantages, and is used by Andluca Technologies as an insulated glass unit (e.g., IGU) because integration into such a window (or door) involves assembling electronics to a glass that produces power via conversion of solar or other radiation into energy via one or more photovoltaic or luminescent solar concentrator approaches to be able to convert UV light into energy for power production. The solar harvesting UV absorbers may harvest ultraviolet (UV) light between the regions of 300 - 420 nm, 350- 420 nm, 350 - 405 nm, etc. In particular, the solar-generating glass may convert light having wavelengths between 300 - 420 nm to electrical power.

In some embodiments, the window system may incorporate silicon PV strips within view of the eye using black silicon PV strips along the perimeter of the glass, and the glass may also act as an LSC. In some embodiments, the system may incorporate semi-transparent solar-generating glass which uses organic photovoltaic coatings or perovskite coatings or inorganic semiconductor coatings. The system may incorporate perovskite devices, as those solar cell types have been shown to produce high performance even as semi-transparent devices. The solar-generating glass may include one or more of perovskite photovoltaic devices or dye-sensitized devices or thin-film inorganic photovoltaic devices.

In some embodiments, the transparent or semitransparent UV solar glass IGU along with the associated energy storage and management system is used as a core integration in such a window or door. This concept can be achieved via glass that harvests UV light. This allows features and applications that need electricity to be powered by the energy storage device without needing power from electricity from the building. The UV solar glass charges the battery as long as UV light from the sun is reaching the surface of the glass. Alternatively, a solar glass may also utilize absorption of a portion of visible and/or near-infrared light reaching the surface of the glass from the indoor or outdoor environment.

The entire self-powered system is a solution that requires no external wired electrical source to power the window or applications and/or features integrated with the window, and it allows the window or door to be installed in a traditional manner, by a glazier, without the need for an electrician. The design and method of the window or door being capable of installation without an electrician is extremely beneficial for ease of installation, lower cost installation, and faster installation, relative to window or glass designs that have external wires for the purposes of power transfer into and/or out of the window or glass.

The pod concept allows different features and/or applications to be added (or removed) or upgraded to a window or door that has been equipped with existing compatible pod receptacle interfaces and/or slots. The pod concept allows this upgrade or installation to be done without any tools, by a mechanically easy fit into the pod receptacle. For example, this electrical connection may be achieved through a quick pogo-pin based or similar connection from the pod receptacle to the pads on the pods or similar pod interface.

The pod and pod receptacle power transfer connection can also be accomplished without physical electrical contact, via now common inductive wireless charging methods such as electromagnetic induction. For example, charge can be transferred from the pod to the pod receptacle using a system that includes an induction coil in the pod receptacle that creates an electromagnetic field, and a receiver coil in the pod that converts the electromagnetic field back into electricity to power pod functionality.

The pods can include dedicated energy storage components such as capacitors or batteries, for local energy use within the pod. In this way, an in-glazing bead, in-frame, or in-window battery or energy storage component can be reduced in size, or eliminated altogether, in favor of energy storage in the pods. A window and a door are designed to isolate the inside from the elements on the outdoor side of the window or the door. This isolation is specifically pertinent to certain weather conditions, thermal conditions, and/or sound conditions. One embodiment allows sensing of outdoor conditions with sensors, while keeping the pod concept intact and maintaining the necessary indoor-outdoor isolation of a traditional window product.

Windows and doors are designed to protect the indoor from the outdoor elements. Since illustrative self-powered smart windows have electrical components, most or all of the electrical parts in a panel may be accessible from the inside only, and isolated from functions that can expose the electrical parts to the exterior (e.g., where the window opens and closes). The pod design also allows electrical parts to be replaced without having to replace the whole window since electrical component lifetime is usually shorter than a window lifetime.

Further, the pods can be designed to segregate PCBs and/or components for specific functions, such that failure of a specific PCB and/or component can be remedied via replacement of the specific pod that has failed, without replacing multiple or all components or pods in the window.

Another characteristic of some embodiments of the self-powered smart window or door is automated functionality with programmed PCBs as well as cloud-based programs pushed to the PCBs. This includes programs that, for example, a user can use information from on-board sensors or information from the internet and/or the cloud. Sensors and algorithms can be used to drive certain relevant functions when sensors and data detect certain conditions and/or stimuli. This enables the window or door to be optimized for the end user’s preference, comfort, security, privacy, and/or wellness, as well as the home, building, or space energy efficiency and/or performance. The window can be easily integrated to a wide variety of smart home platforms or network connectivity protocols such as Zigbee, WiFi, Bluetooth, cellular, LoRaWAN, or similar, and various window functionality can also drive functionality and be driven with voice commands such as through a smart home platform.

This integrated window system is self-powered without the need for any external power supply, either permanently or via rechargeable or replaceable batteries. So, such that, it is self-contained and self-powering.

The pod concept allows for modularity, adaptability, and upgradability with the potential for multiple functions that change out over time in a straightforward manner, manageable by the user.

The exterior-internal interconnects allow for isolation of the interior, electronic components, and the interior environment, while providing physical wiring access to sensors and accessories on the exterior of the window unit.

The self-powered smart window also allows for automated functionality, using the sensor inputs to inform algorithms to drive certain functions of other attached elements. This allows optimization for the end user’s preference.

In some embodiments, the pod concept applies to windows that are designed with transparent or semitransparent UV solar glass, include energy storage and management systems, and a pod concept panel. The pod concept panel can be hidden in a glazing bead, or displayed on a surface of the self-powered window. In embodiments, the pods may be incorporated into glazing beads and visible surface mounted pods.

The solar glass harvests ultraviolet light to produce power via conversion of solar or other radiation into energy via one or more photovoltaic or luminescent solar concentrator approaches for power production. In some embodiments, the solar glass can additionally harvest a portion of visible and/or near-infrared light reaching the surface of the glass from the indoor or outdoor environment.

The window buyer does not need to decide up front, before purchasing the window with pod receptacles, which pods with which specific features and/or applications are desired. The window buyer only needs to decide if they want a window with the future ability to have those features. If a window buyer makes that choice, this decision of specific pods specifics can be made later. This separation of feature and pod selection, purchase, delivery, and installation, enables advantages for window businesses and electronics businesses to focus on core competences; namely, windows and electronics, respectively. For example, the window or door can be manufactured with none, some, or all the mechanical and electrical elements of the window or door system described herein, such as the internal power transmission connections between the solar glass and the pod receptacles. The window or door may be manufactured with none, some, or all of the pods installed in the pod receptacles. The window or door can also be manufactured and delivered with faux pods that serve to protect the pod receptacles but are removed and replaced with functional pods once the window or door are installed. The described faux pod approach to manufacturing and packaging of the window, allows for lower failure rates during distribution, shipping, and glazing and/or window installation.

In some embodiments, the self-powered window system can have the functionality of all of features and/or applications such as; window lock and unlock, window open and close, window information display, battery charging or other energy storage, energy management, temperature sensing, humidity sensing, proximity sensing, camera sensing (e.g., imaging), outside temperature sensing, inside temperature sensing, functionality through buttons, functionality through voice activated commands, and the like, as well as and demonstration of similar features and/or applications.

Some embodiments of the self-powered window system may use a UV solar glass as a source of energy generation, store harvested energy in a battery, manage the use of the energy through an energy management PCB board, power applications in the form of functional feature pods, and enable automation through built in sensors and integration with a smart home platform.

In some embodiments, the self-powered window system may include a window mount that allows the self-powered window to open to the exterior and to close again. The window mount may allow the window to be opened manually by a user inside of the building. The window mount also may allow the window to be opened and closed electronically by a user.

In some embodiments, the self-powered window system may include a security pod that includes a motion sensing camera and an alarm, as well as a wellness pod that can sense a comfortable environment through temperature and humidity sensors. Such security pods and wellness pods may be integrated in a self-powered window system with the ability to open and close a self-powered window through motorized operation. That is, in some embodiments, the self-powered window system may sense the presence of an occupant in a building and sense the environmental conditions inside and outside of the building and open or close the window according to preset conditions.

In some embodiments, the self-powered window system concept may have a lock and unlock feature that can be operated remotely and integrated with a smart home platform.

In some embodiments, the self-powered window system may have pods that allow for connecting of external electronic devices. The connector in the pod may include Universal Serial Bus (e.g., USB) connectors, High-Definition Multimedia Interface (e.g., HDMI) connectors, XLR connectors, Radio Corporation of America (e.g., RCA) connectors, Registered Jack 45 ( RJ45) connectors, Registered Jack 11 (e.g., RJ11) connectors, UTP connectors, BNC (e.g., Bayonet Neill-Concelman) connectors, F-Type connectors, N-Types connectors, Lucent connectors, Subscriber connectors, DC power connectors for applications such as power supplies, laptops, routers, and CCTV cameras, and mobile device connectors including low-power charging using 2xMicro USB, Mini USB, 8-Pin lightning, and USB Type-C connectors.

In some embodiments, the self-powered window system concept with features/functional pods, various embodiments add a different pod style/form that leverages the horizontal removeable glazing beads of a typical window frame system. This design preferably enables power from the UV solar glass to be available at a plurality of locations. One location, for example, may be at the top half of the frame and the second may be an independent power circuit at the bottom half of the frame. This example enables two horizontal feature pods to be available: one at the top and one at the bottom. Indeed, more locations enables availability of more feature pods. Those in the art may implement the locations in any of a variety of manners. For example, the availability of power at any of the locations may enable power for a standard household plug (e.g., US plugs or European plugs). One or more also could be in the form of a USB or USBC port, or other form factor known in the art or not yet developed.

This horizontal pod design enables functionality that can span the entire viewable area of the window. One feature of a window is privacy, which may include a privacy pod that provides this feature to the home occupant. The privacy pod is similar in concept to the previously described pods with other features, such as security and/or wellness features. Like other pods, the privacy pod can be easily installed and removed—i.e., it may be removably connectable to the window and/or window frame. The pods can be replaced and upgraded easily and thus, preferably are modular. Depending on features desired for the application and end user, those features can be included in the pod that is attached in the horizontal pod opening – whether it is privacy pod, security pod, or a combination of security and privacy pod. The pods connect easily with the power port from the UV solar glass via a USB-C or other power and data ports.

### Glazing beads

In some embodiments, the pods are designed to integrate with the glazing beads of a window frame system. Glazing beads are used to keep the glass in place and are removeable pieces that fasten to the window frame system. Integrating the horizontal pod with the glazing bead frame elements allows for no modification to the main frame elements. Not having to modify the structural window frame elements preserves the core functionality of the window frame and does not add any failure risk to the window frame system. The only modification required is to the glazing bead.

Modifications to the glazing beads are minimal and only involving some hole punches and/or some mechanical fastening, which are processes not unfamiliar to window fabricators. Thus, the designs disclosed herein result in manufacturing advantages such as streamlined production, minimal disruption to existing processes, minimal additional labor, lower failure rate of products, and the like. Modifications to glazing beads have negligible impact to the manufacturing process for the glazing bead elements as well as window fabrication process. Glazing beads that integrate with horizontal pods still preserve the ability to be manufactured by extrusion, so there is negligible impact to current manufacturing operations.

Some privacy pods may be designed with a shade fabric that is extremely thin, with complete blackout functionality and, in some case, non-negligible sunlight reflecting capability, allowing the privacy pod to also provide cooling effects that also can significantly reduce cooling energy requirements. As a blackout fabric, this also allows the user to block glare from the sun. This high-end thin fabric also allows a lightweight design, enabling small tubular motors (or similar) to be used which require less power than larger diameter motors, and the thinner motor profile adds a slim design aesthetic that is attractive. The horizontal privacy pod is also designed so you can replace the fabric for a different color easily.

Some or all of the electronic elements of the privacy pod assembly can be housed inside the tubular motor. This includes the battery, the battery management system, the energy management system, the board that drives the motor, and all communication hardware and protocol needed to integrate with most smart home platforms.

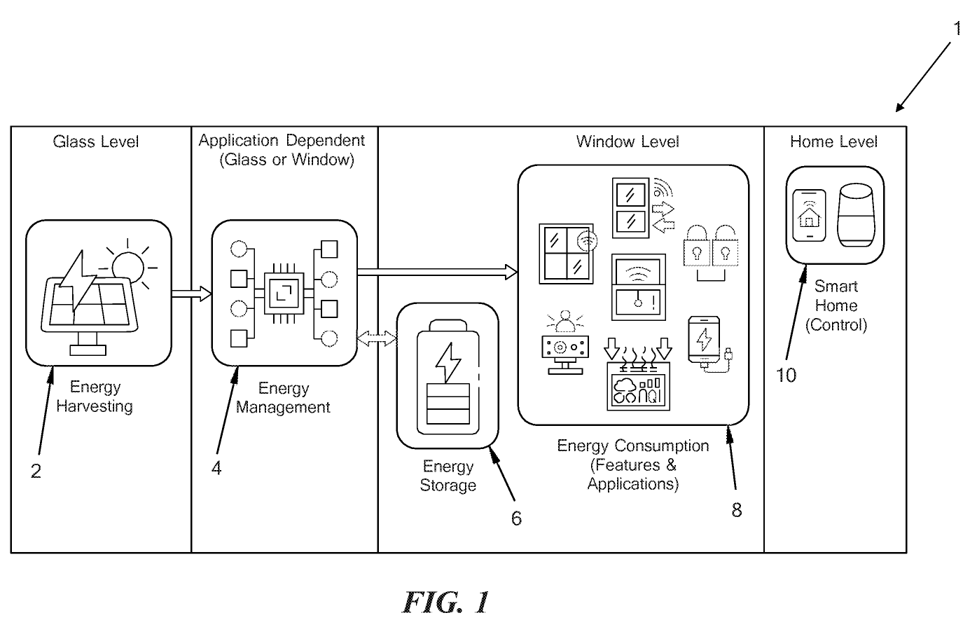

FIG. 1 shows a schematic illustration of a high-level system design of a self-powered smart window system 1. The self-powered system 1 includes an energy harvesting component 2 to provide electrical energy to the entire system. The system has an insulated glass unit (e.g., IGU) that includes a solar-generating glass to convert the solar radiation incident on the solar glass to electrical energy. In embodiments, the solar glass converts the ultraviolet (e.g., UV) portion of the solar spectrum to energy and allows the visible portion of the spectrum to pass through the glass into the structure.

The self-powered smart window system 1 includes an energy management component 4 to manage the storage and distribution of electrical energy to the entire system. The energy management system 4 controls the energy distribution in an application dependent manner to the glass or window in the IGU. The energy management system 4 may include power and energy management boards with PCBs that are specifically designed for a specific system or adapted from general designs.

The self-powered smart window system 1 includes an energy storage component 6 comprising one or more storage devices in electrical communication with the energy management component. The energy storage device may include one or more a rechargeable batterie. The rechargeable batteries may be any one of a nickel-cadmium (NiCd) battery, a nickel-metal hydride (NiMH) battery, a lithium-ion (Li-ion) battery, or a lead-acid battery. The one or more rechargeable batteries may be located in different pods or inside a frame of a structure housing the smart window system.

The self-powered smart window system 1 includes one or more energy consuming functional components 8 that provide features, applications and functions. These features, applications and functions may be located in reversibly installed pods. One example of the functions/features provided by the smart window system include a privacy function. The privacy function may include a motorized smart shade integrated into a privacy pod.

Another example of functions/features provided by the smart window system 1 includes is a security function. The security function includes features such as a security camera, a proximity sensor, a speaker, a motion sensor, or lock and unlock sensors paired with impact-resistant glass. The security features may be reversibly installed in one or more pods in the smart window system individually or in a feature set. One example feature set may include, without limitation, a security camera, a proximity sensor, and an alarm.

Another example of functions/features provided by the smart window system 1 includes a dynamic window tinting and/or dimming function. The dimming and/or tinting function may be provided by electrochromic (EC) layers of a dynamic glass that are combined with the solar-generating glass in the IGU. The dynamic tinting enhances energy efficiency and occupant comfort as the dynamic glass responds to sun exposure to control glare, heating, and reduce peak energy load. The EC layers may be powered directly by the energy harvesting component, or indirectly by the energy storage component. Additional dynamic glass devices may include electroplating device (EP glass), suspended particle device (SPD), and/or polymer dispersed liquid crystal (PDLC) device.

Still another example of functions/features provided by the smart window system 1 includes an on-demand power function. The on-demand power function provides a stand-by power source for low powered applications that is continuously replenished by the sun through the solar-generating glass.

The smart window system 1 also includes a controller component that is connected to and monitors the other components of the smart window system. In addition to being connected to the energy harvesting component, the energy management component, the energy storage component, and the one or more energy consumption functional components, the controller also controls the energy management and the functional components.

An optional component of the smart window system 1 includes a smart home control 10 that may to linked to the controller component. The smart home control is smart home compatible and allow the user to control the smart window system remotely through intelligent, cloud-based home virtual assistants and internet of things (IoT) devices.

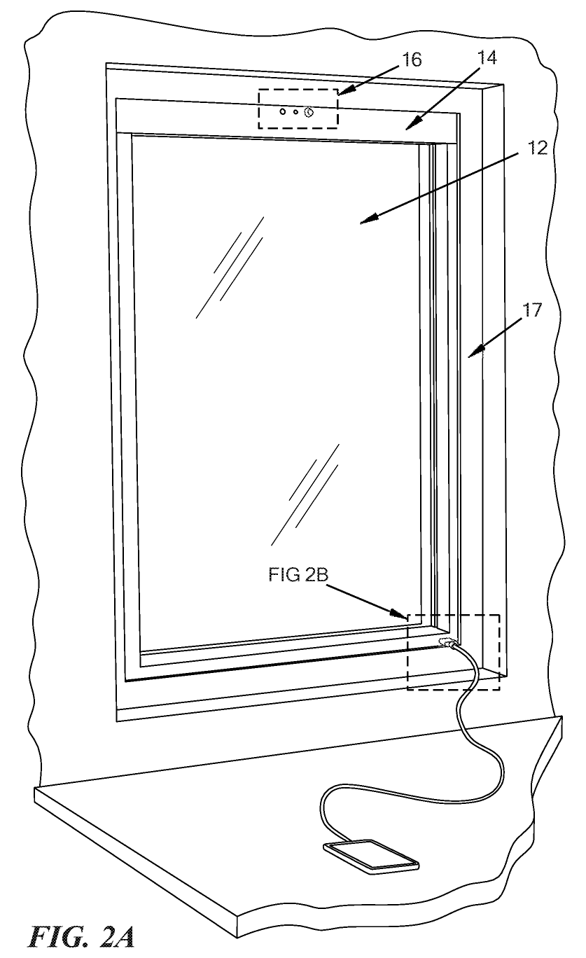

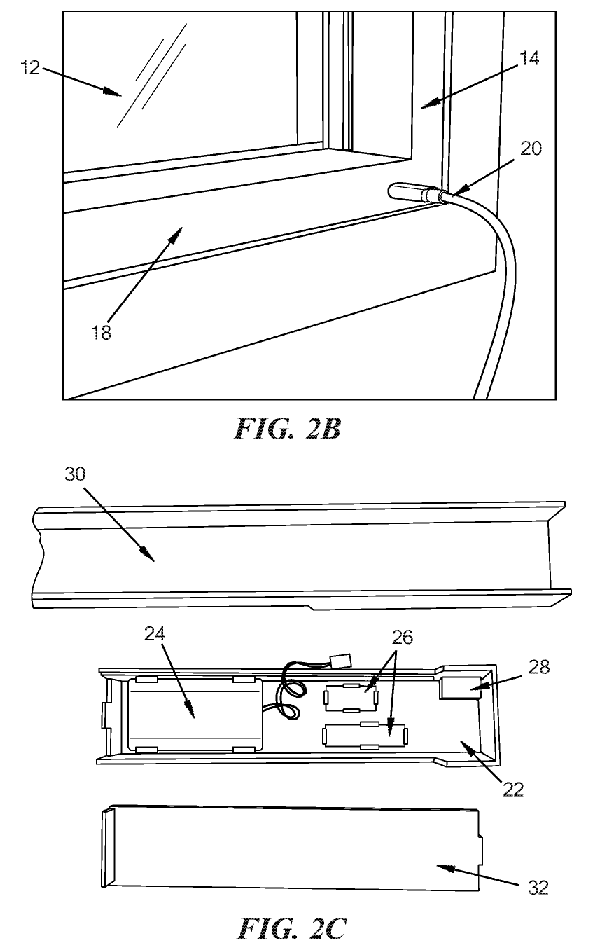

FIG. 2A shows a drawing of an embodiment of a self-powered smart window design viewed from the inside of the window. The smart window design includes solar-generating glass 12 mounted in the window. The solar power generating glass 12 is transparent or semitransparent to visible light yet provides direct current (DC) current to window components. The solar-generating glass 12 absorbs ultraviolet (UV) radiation from the sunlight incident on the window and allows visible light to pass through the window.

A glazing bead 14 surrounds the window 12 and holds the window 12 in place, as well as provide desired features, accessories, and/or applications. In some embodiments, the glazing beads are designed in horizontal orientations to position pods on the inside portion of the top and bottom frame elements. For example, a non-limiting feature set 16 of security pod features are shown in the top glazing bead in FIG. 2A. A frame 17 surrounds the glazing bead 14 and solar-generating window 12 and it provides secured attachment to the structure.

FIG. 2B shows an expanded illustration of the low power charging pod 18 with a charging cable 20 plugged into the charging (e.g., power) pod 18 in the glazing bead 14 through a USB-C plug. The solar-generating window 12 provides electrical power to the window system.

FIG. 2C shows an embodiment of a charging pod section 22 and a blazing bead 30 that hosts the charging pod section 22. The charging pod section 22 may holds batteries, energy management boards, power plugs, and the like. The power pod inserts 22 is shown securing features that provide energy storage 24 (e.g., a battery), power and energy power and energy management 26 (e.g., power and energy management boards), and power connection features 28 (e.g., USB-C plug and board). A power pod cover 32 is also shown in FIG. 2C.

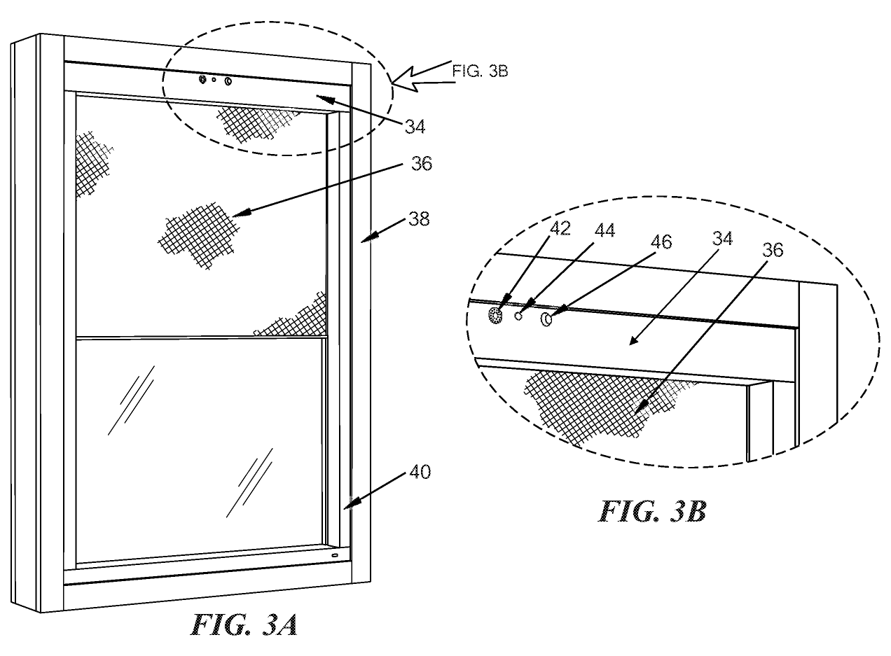

FIG. 3A shows a drawing of an embodiment of a self-powered smart window design including a pod with privacy shade 36 and security features integrated into a horizontal glazing bead 34. The privacy shade 36 may be a state-of-the-art art thin fabric that reflects sunlight, significantly reducing solar heating and energy consumption due to HVAC operations. A window frame 38 and side glazing bead 40 are also shown in FIG. 3A.

FIG. 3B shows an expanded view of the embodiment of the self-powered smart window design in FIG. 3A. As shown, the pod combines an alarm 42, camera 44, and proximity sensor 46 with the roller shade 36 (e.g., privacy shade) all positioned in the glazing bead 34.

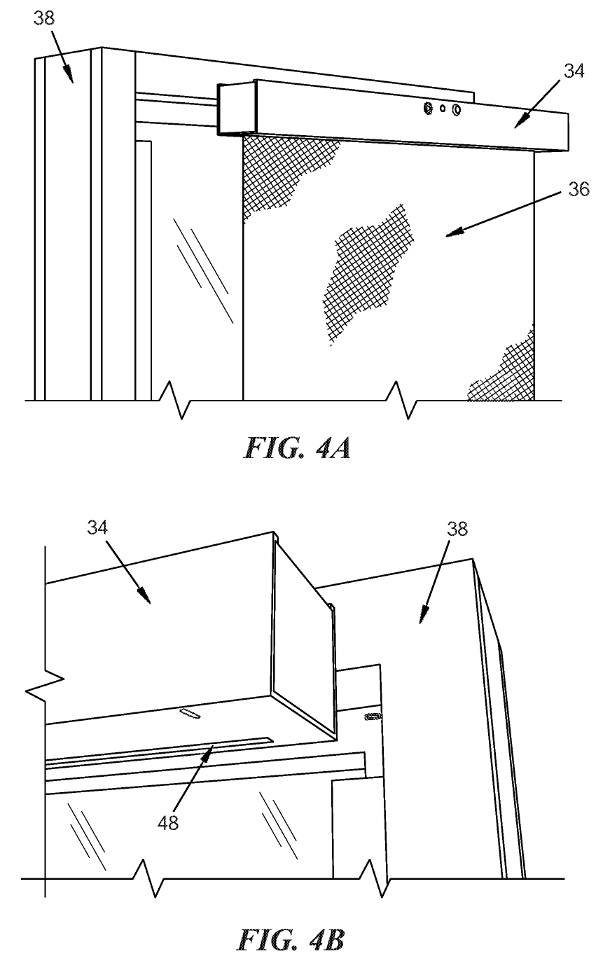

FIG. 4A illustrates mounting (e.g., installing) a the glazing bead 34 that includes a privacy shade 36 and security features. The pod is integrated into a glazing bead 34 and can be easily fit into the frame 38. The glazing bead 34 can be easily uninstalled and reinstalled as options desired by the user change or repairs need to be made.

FIG. 4B further illustrates mounting a glazing bead 34 that includes window shade pod into a frame. A slot 48 for extension and retraction of the window shade is shown on the bottom of the blazing bead 34. FIGS. 4A and 4B illustrate the ease and reversibility of installing (e.g., mounting) and removing (e.g., unmounting) glazing beads that contain pods.

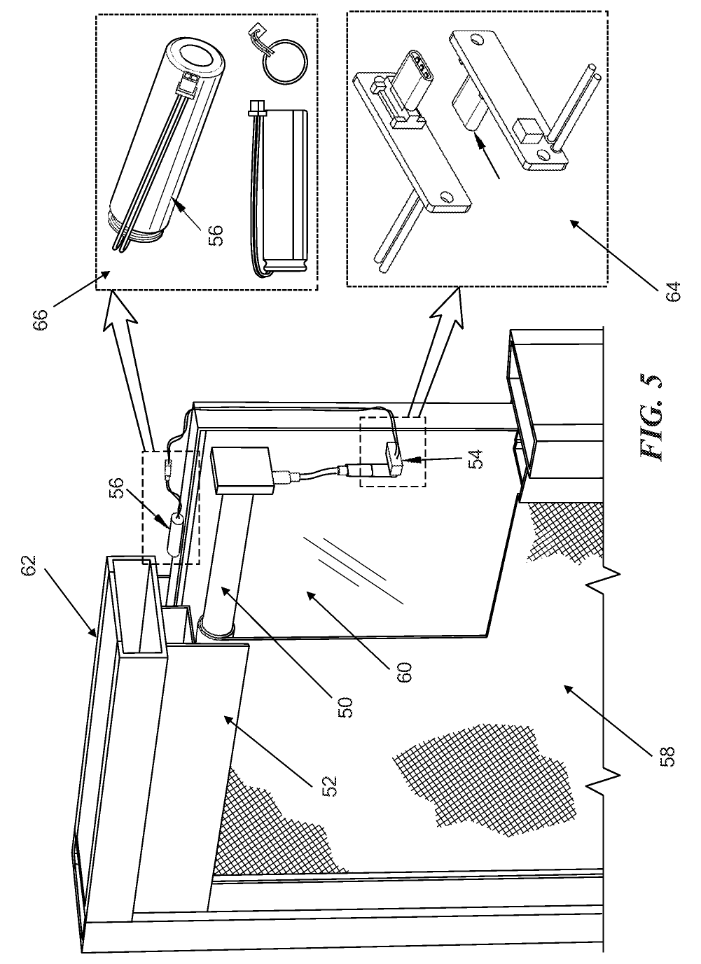

FIG. 5 shows a drawing illustrating details of an embodiment of an integrated adaptive shade (e.g., security shade pod). A roller assembly 50 is positioned in a glazing bead 52. The security shade pod includes energy management connectors 54 and energy storage device 56 (e.g., a battery). The roller shade material 58 is deployed on the inside of the solar-generating window 60. In some embodiments, the battery 56 may be recharged with energy directly from the solar-generating window 60. While, in other embodiments, the battery 56 is charged with energy from the energy storage devices that are part of the system power management components. The glazing bead 52 is mounted in an aluminum frame 62 (e.g., structure). Detailed drawings of the energy management connectors 54 and energy storage device 56 are shown in boxes 64 and 66, respectively.

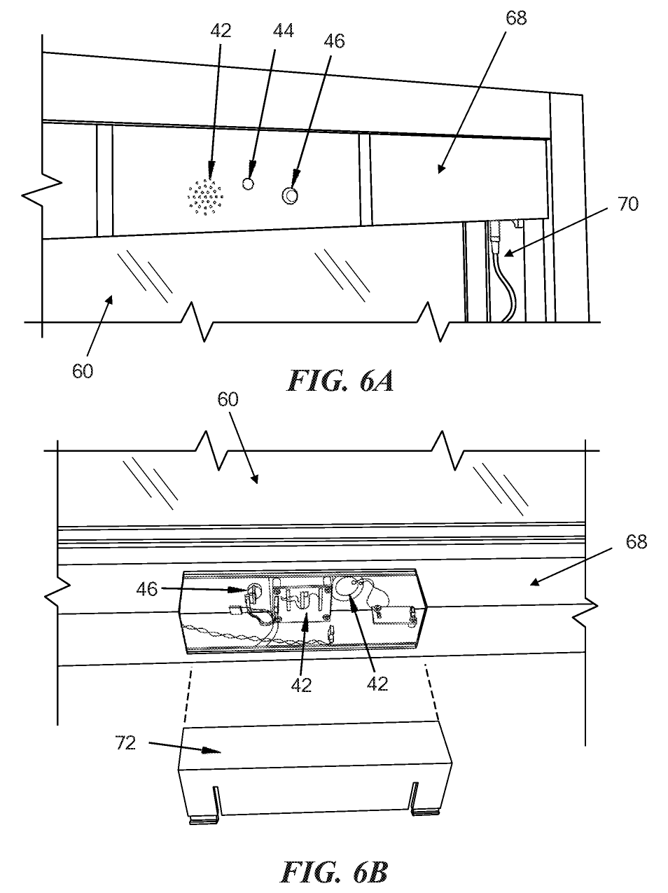

FIG. 6A shows a drawing of the front of a glazing bead 68 containing a security pod as part of self-powered smart window design highlighting the security features. As shown, the security pod combines an alarm 42, a camera 44, and a proximity sensor 46. The inclusion of these particular security features is not exclusive, as any combination of features may be assembled to provide the user with a customized security product. The security function of the system 1 comprises features that include one or more of a security camera, a proximity sensor, a speaker, a motion sensor, or lock and unlock sensors paired with impact-resistant glass in one or more pods. A internal power supply cable 70 that provides energy management and control is shown, as is a solar-generating window 60.

FIG. 6B shows a drawing of the back of the blazing bead 68 with the security pod and shows the cover 72 removed showing the back of the security electronic devices, the alarm 42, the camera 44, and the proximity sensor 46. The solar-generating window 60 is also shown.

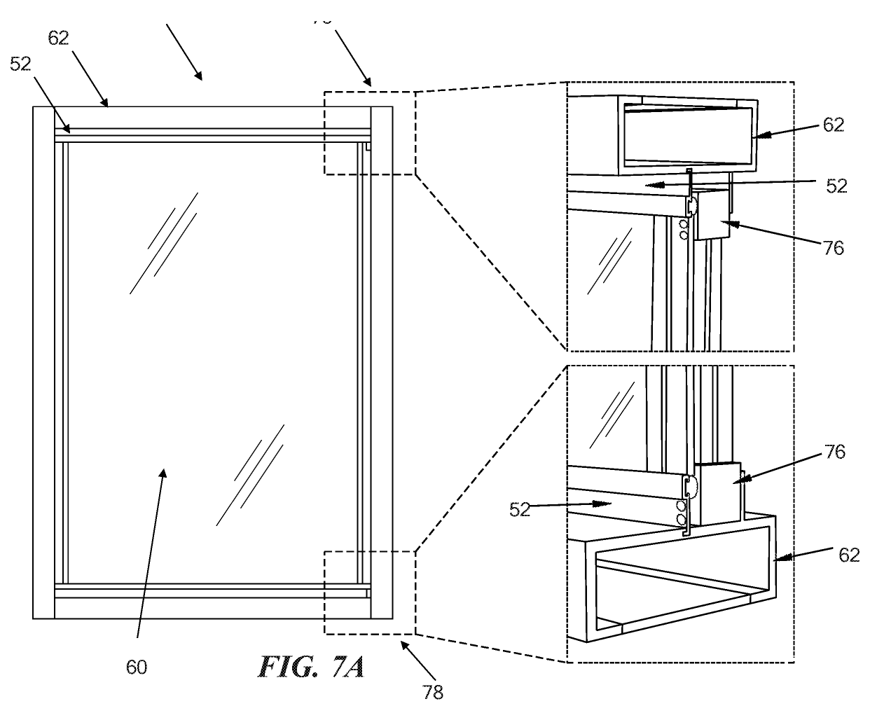

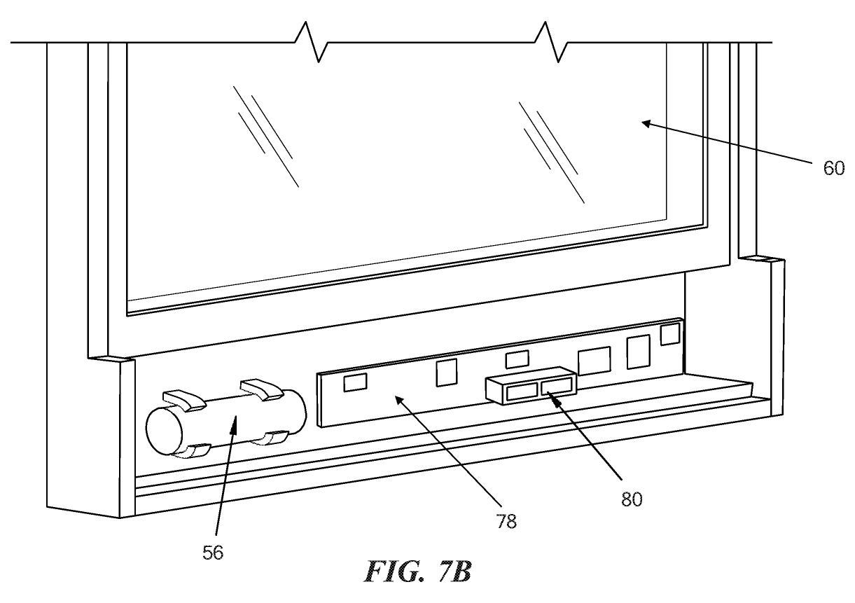

FIG. 7A shows a drawing of an embodiment of a self-powered window 74 that includes cut-away illustrations of upper 76 and lower 78 right corners of the window 74. The outer structure of the self-powered window 74 includes a window frame 62 into which is mounted a glazing bead 52. A pod 76 is positioned in the glazing bead 52. A solar-generating window 60 is also shown.

FIG. 7B shows a drawing of the backside of a self-powered window that illustrates devices inside a pod with the cover removed according to an embodiment of the present disclosure. A battery 56, an electronics board 78, and an electrochromic device control board 80 are shown in the pod, and a solar-generating window 60 is also shown.

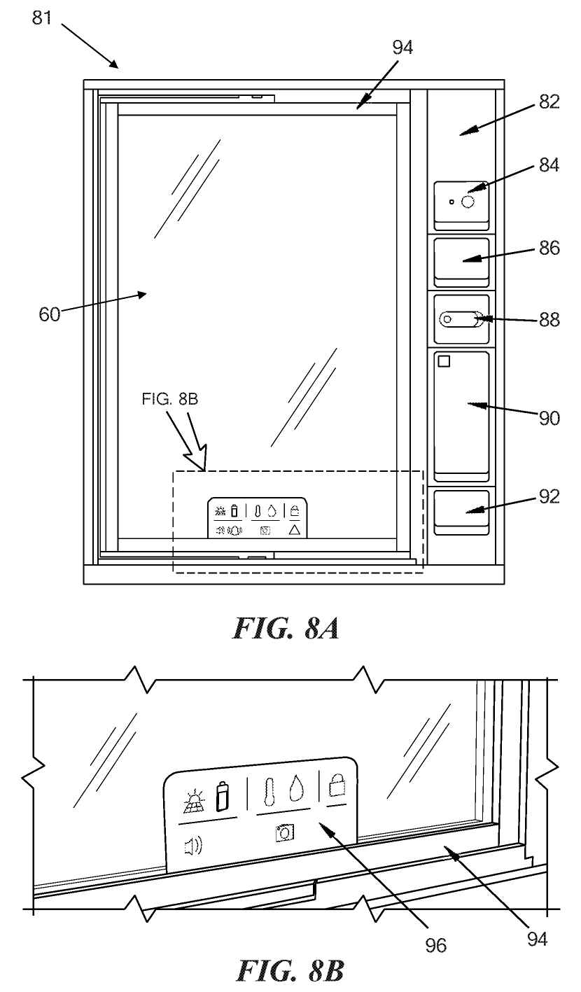

FIG. 8A shows a drawing of an embodiment of a self-powered smart window 81 with pods located on an outer surface on a window frame 82 viewed from the inside of the window. The pods shown on the frame 82 include a security pod 84, a wellness pod 86, a manual lock 88, a main pod 90, and a manual override 92. A glazing bead 94 is inside of the frame 82. A solar-generating window 60 is also shown.

FIG. 8B shows a rendering of an expanded portion of the window embodiment of a self-powered smart window 81 with a display 96 as part of the IGU. The glazing bead 94 is shown adjacent to the solar-generating window 60.

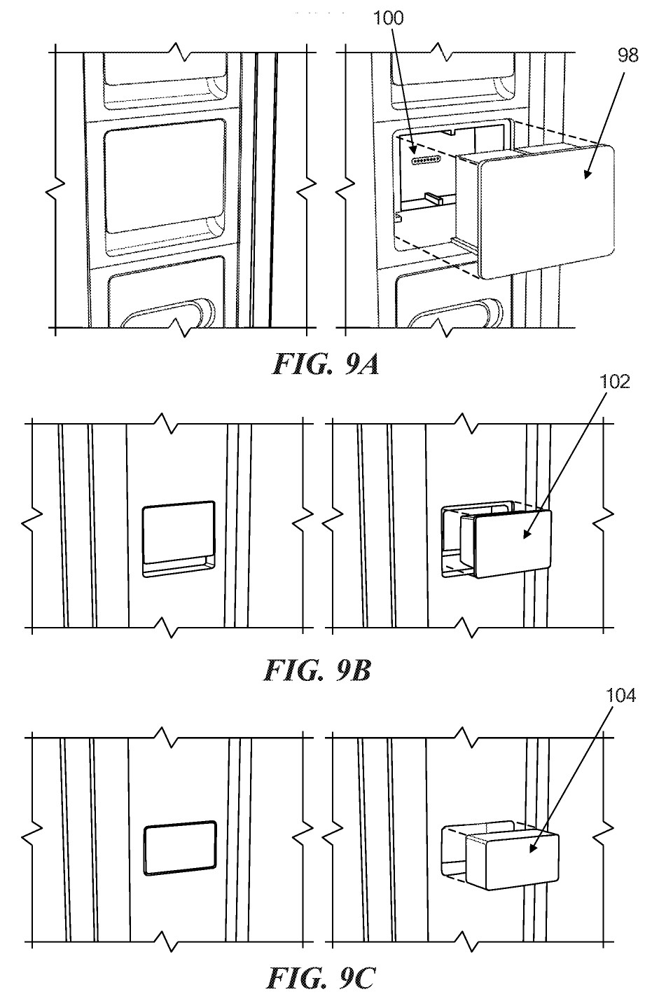

FIG. 9A shows a drawing of an embodiment of easy insertion, engagement, and removal of pods on a surface of the self-powered smart window system according to an embodiment of the present disclosure. FIG. 9A shows a pod 98 that is capable of making an electrical connection through a quick pogo-pin based connection 100 from the pod receptacle to the pads on the pods.

FIG. 9B shows another rendering of an embodiment of easy insertion, engagement, and removal of a pods102 according to an embodiment of the present disclosure.

FIG. 9C shows an additional rendering of an embodiment of easy insertion, engagement, and removal of a pod 104 on a surface of the self-powered smart window system according to an embodiment of the present disclosure.

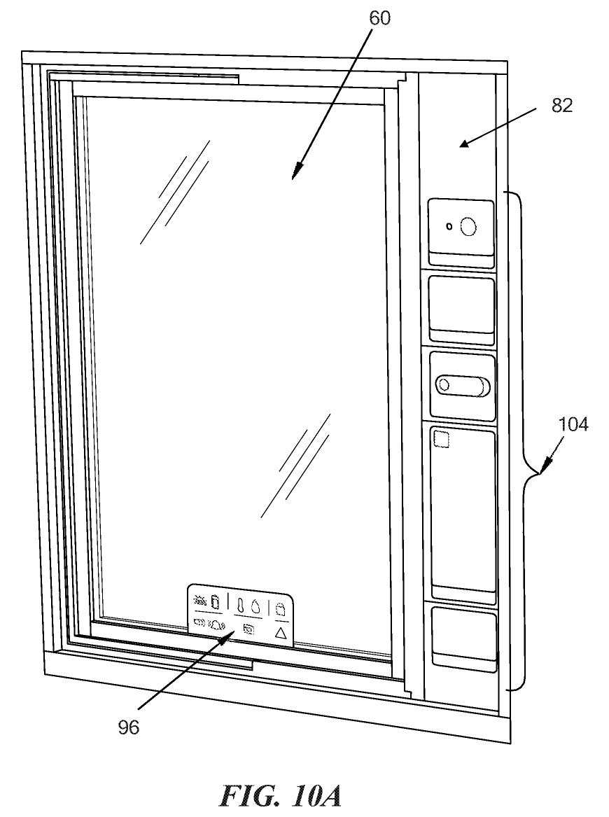

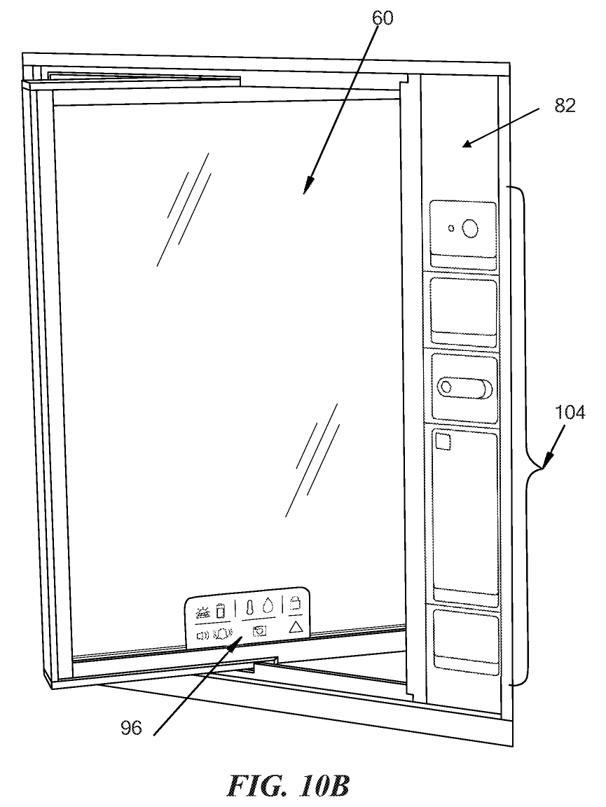

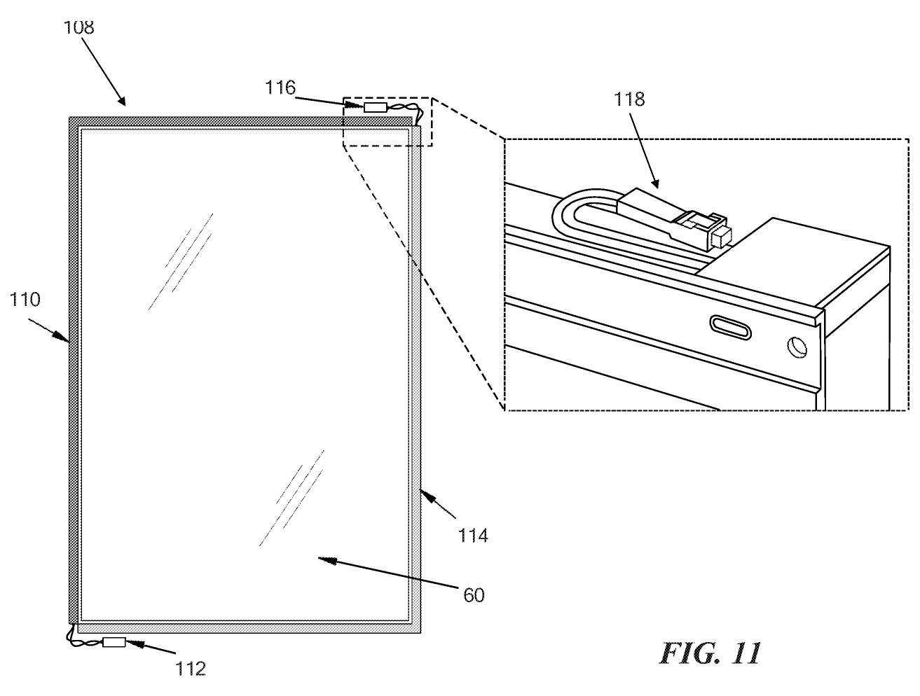

FIG. 10A shows a rendering of an embodiment of a self-powered smart window system with pods 106 located on the surface on a window frame 82 with a closed solar generating 60 window and a display 96 according to an embodiment of the present disclosure.

FIG. 10B shows a rendering of an embodiment of a self-powered smart window system with pods 106 located on the surface on a window frame82 with an open solar generating 60 window and a display 96 according to an embodiment of the present disclosure.

FIG. 11 shows a solar-powered glass window IGU 108 having electrical connections and showing a connection to the IGU. The surface of the solar-generating window 60 is shown. The IGU has two sets of solar cells with two sets of connections. The first set of solar cells are connected along the left side and top of the IGU with a first edge treatment 110. They have a first electrical connector 112. The second set of solar cells are connected along the right side and bottom of the IGU with a second edge treatment 114. They have a second electrical connector 116. The expanded insert shows a detailed illustration of the connector 118 for the second set of solar cells. The connector 118 is going to be plugged into a pod or a circuit to provide electrical power to the smart window system 1.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A self-powered window system, the window system comprising:
solar-generating glass, the solar-generating glass configured to provide a source of electrical power to the window system;
one or more pods configured to hold one or more features;
an energy management system in electrical communication with the solar-generating glass, the energy management system configured to optimize storage and distribution of the electrical power provided by the solar-generating glass;
at least one energy storage device positioned in at least one pod, the at least one energy storage device configured to be in electrical communication with the solar-generating glass;
one or more electrical circuits configured to distribute the electrical power to the one or more pods and the at least one energy storage device; and
a structure configured to secure at least the solar-generating glass, the one or more pods, and the at least one energy storage device within the structure,
wherein the window system is self-contained such that the electrical power required to operate the one or more features, to energize the one or more electrical circuits, and charge the at least one energy storage device is provided by the solar-generating glass.

2. The window system of claim 1, wherein the one or more features comprise at least one of a power pod, a security pod, a privacy pod, a gas sensor pod, an alarm pod, a clock pod, a camera pod.

3. The window system of claim 1, wherein the one or more pods are reversibly installable in the structure.

4. The window system of claim 1, wherein the structure comprises one or more glazing beads.

5. The window system of claim 4, wherein the one or more glazing beads comprise at least one of the one or more pods.

6. The window system of claim 5, wherein the one or more pods are configured to be reversibly mounted as part of the glazing beads.

7. The window system of claim 1, wherein the structure comprises a glazing bead configured to be mounted within a window frame.

8. The window system of claim 1, wherein the one or more pods are configured to mounted onto the window frame.

9. A self-contained smart window system, the window system comprising:
an energy harvesting component, the energy harvesting component comprises an insulated glass unit (IGU) comprising solar-generating glass configured to provide a source of electrical power to the window system;
an energy management component, the energy management component in electrical communication with the solar-generating glass and configured to optimize storage and distribution of the electrical power generated by the solar-generating glass;
an energy storage component, the energy storage component comprising one or more storage devices in electrical communication with the energy management component;
one or more energy consuming functional components, the one or more energy consuming functional components provide at least one of a privacy function, a security function, a dynamic window tinting function, or an on-demand power function;
a smart window system controller component, the smart window system controller component in electrical communication with the energy harvesting component, the energy management component, the energy storage component, and the one or more energy consuming functional components and configured to control energy management and the functional components; and
a structure configured to secure at least the energy harvesting component, the energy management component, the energy storage component, the smart window system controller component, and the one or more energy consuming functional components within the structure,
wherein the window system is self-contained such that the electrical power required to power the components is provided by the solar-generating glass.

10. The window system of claim 9, further comprising:
a smart home control component, the smart home control component in control communication with the smart window system controller.

11. The window system of claim 9, wherein the structure comprises:
one or more glazing beads;
a window frame; or
both the one or more glazing beads and the window frame.

12. The window system of claim 9, wherein the solar-generating glass converts ultra-violet (UV) light to electrical power.

13. The window system of claim 12, wherein the solar-generating glass comprises one or more of organic photovoltaic devices (OPV) or a luminescent solar concentrator (LSC) devices.

14. The window system of claim 13, wherein one or both of the OPV devices or LSC devices are UV OPV devices or UV LSC devices.

15. The window system of claim 9, wherein the IGU further comprises one or more layers of dynamic glass.

16. The window system of claim 15, wherein the one or more layers of dynamic glass comprises an electrochromic (EC) layer.

17. The window system of claim 16, wherein the EC layer is electrically dimmable.

18. The window system of claim 16, wherein the EC layer is electrically tintable.

19. The window system of claim 11, wherein the energy management component comprises one or more energy management boards positioned in one or more pods reversibly installed in the structure.

20. The window system of claim 11, wherein the energy storage component comprises one or more batteries positioned in one or more pods reversibly installed in the structure.

21. The window system of claim 11, wherein the privacy function comprises providing a motorized smart shade integrated into a privacy pod reversibly installed in the structure.

22. The window system of claim 9, wherein the security function comprises features comprising one or more of a security camera, a proximity sensor, a speaker, a motion sensor, or lock and unlock sensors paired with impact-resistant glass in one or more pods reversibly installed in the structure.

23. The window system of claim 9, wherein the dynamic window tinting function comprises an EC layer in the IGU.

24. The window system of claim 11, wherein the on-demand power function comprises a power pod insert reversibly installed in the structure.

25. A method of providing privacy, security, and energy efficiency to an interior structure having a window frame, the method comprising:
providing a self-contained smart window system; and
mounting the self-contained smart window system in the window frame, the self-contained smart window system comprising:
solar-generating glass, the solar-generating glass configured to provide a source of electrical power to the window system;
one or more pods configured to hold one or more features;
an energy management system in electrical communication with the solar-generating glass, the energy management system configured to optimize storage and distribution of the electrical power provided by the solar-generating glass;
at least one energy storage device positioned in at least one pod, the at least one energy storage device configured to be in electrical communication with the solar-generating glass;
one or more electrical circuits configured to distribute the electrical power to the one or more pods and the at least one energy storage device; and
a structure configured to secure at least the solar-generating glass, the one or more pods, and the at least one energy storage device within the structure,
wherein the window system is self-contained such that the electrical power required to operate the one or more features, to energize the one or more electrical circuits, and charge the at least one energy storage device is provided by the solar-generating glass.
